(19) United States
(12) Patent Application Publication
(10) Pub. No.: US 2010/0292861 A1
(43) Pub. Date: Nov. 18, 2010

(54) Networked power control system

(76) Inventors: Leonard Tsai, Santa Clara, CA (US); Darwin Chang, Cupertino, CA (US); Hing S. Tong, Saratoga, CA (US)

Correspondence Address: Leonard Tsai, 2290 Menzel Place, Santa Clara, CA, 95050, US

(21) Appl. No.: 12/454,374

(22) Filed: May 18, 2009

(51) Int. Cl. G06F 1/32; G06F 1/26

(52) U.S. Cl. 700/296; 700/3

(57) ABSTRACT

A method for network energy controller that can optimize total system power consumption is provided. The controller (100) collected device loads and report to a common device (270) for optimization. The controller is able to communicate both to other controllers on the same power source or to the internal device (205) that is connected to the controller. The common device is able to respond to power changes reported by controller and request other controller to reduce power so that the entire system power consumption can meet or optimized toward the power policy goal.

### BACKGROUND OF THE INVENTION

1. Field of the Invention

Embodiments of the present invention generally relate to energy management. More specifically, embodiments of the present invention relate to the to the optimization processing of network of energy control devices.

2. Description of the Related Art

Energy management are rapidly becoming the new design direction of the 21st century. Governments are trying to encourage individual citizens to be more responsible for their consumption of energy by different incentives and investments.

Quite frequently, however, various devices exists in daily life were designed without these considerations. Some of more equipped devices like personal computers with modern operating systems does contain such energy management features but in general, majorities of the devices and appliance lacks such function to manage their energy use. Newer appliance and devices typically will provide one power saving mode which reduce general energy consumption.

### SUMMARY OF THE INVENTION

A System of optimized networked energy control devices is provided. The System can include, but are not limited to: one and/or more energy controlling devices, fit to existing appliance externally or build into newer appliance internally. Each of the energy controlling devices can turn on or turn off the power to the devices under control. Some of the energy controlling deices can regulate the power to the devices under control. Each of the energy controlling devices can collect the energy consumption information of the device under control and communicate to other energy controlling devices using different means.

One of the energy control device or a separate device will be the master device that summarize, process, and communicate the result to the user. A controller having a plurality of functions can be operably connected to the outside network. Each of the energy control device can be addressed with a unique serial number for identification. The collection of the unique serial numbers can be used to form the network.

As used herein, the term “network” can refer to the connection of any means, wired or wireless, between two individual energy controlling devices and/or between each of the energy controlling device and the master device.

As used herein, the term “power” can refer to the power type of any means, alternative current, direct current, battery, solar, and/or other means of electricity generating device, method or source.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic circuit, software, or other entity. Logical and/or physical communication channels can be used to create an operable connection.

A method to calculate the optimized setting of each energy control device is provided as example.

### BRIEF DESCRIPTION OF THE DRAWINGS

Advantage of one or more disclosed embodiments may become apparent upon reading the following detailed description and upon reference to the drawings in which:

FIG. 1 is a schematic depicting an illustrative energy control device, according to one or more embodiments described herein;

FIG. 2 is a schematic depicting an illustrative system using the illustrative system depicted in FIG. 1 for the network connection, according to one or more embodiments described herein;

FIG. 3 is a logic flow diagram depicting an illustrative method for energy control information collection in FIG. 1, according to one or more embodiments described herein;

FIG. 4 is a logic flow diagram depicting an illustrative method for the device in FIG. 1 to establish network connection with other devices in FIG. 2, according to one or more embodiments described herein;

FIG. 5 is a logic flow diagram depicting an illustrative method for the optimization of multiple energy control devices in FIG. 2, according to one or more embodiments described herein; and

FIG. 6 is a logic flow diagram depicting an illustrative method for the process when one or multiple energy control devices in FIG. 2, change its power consumption state according to one or more embodiments

### DETAILED DESCRIPTION

Described herein are exemplary systems and methods for implementing networked power control system. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

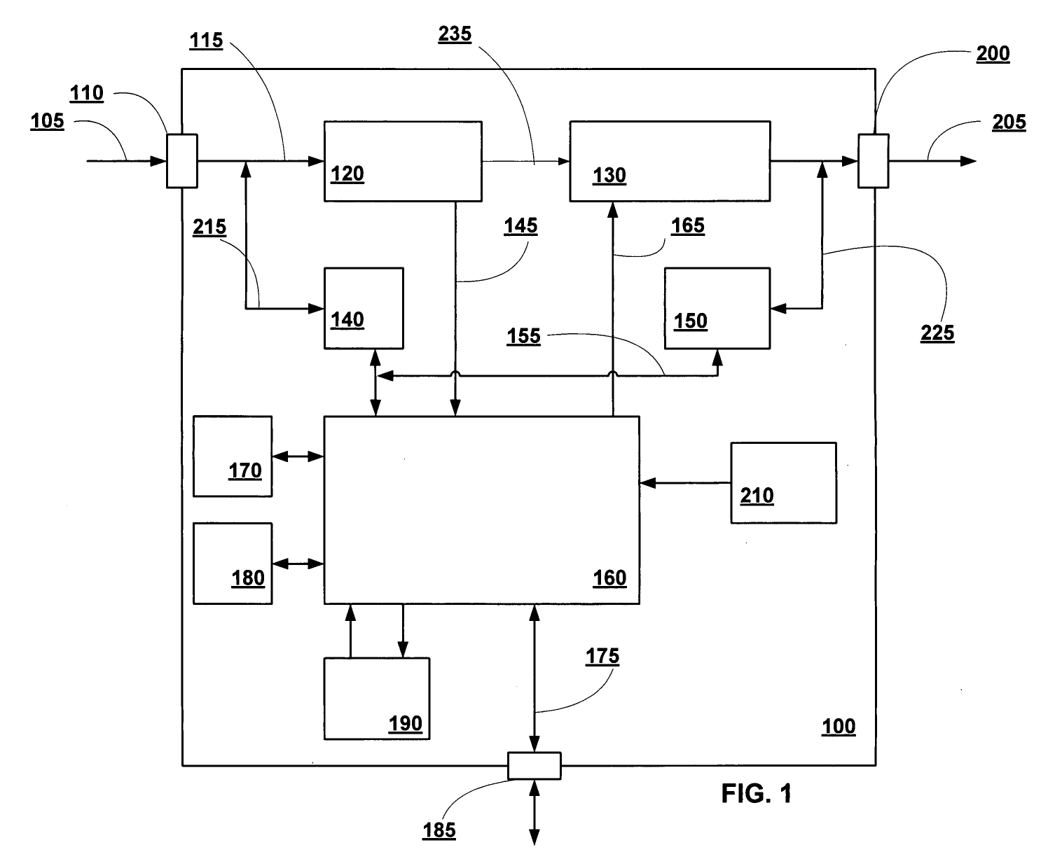

FIG. 1 is a schematic depicting an illustrative system 100 for energy control device, according to one or more embodiments. In one or more embodiments, a first input 110 is connected to the external power source 105. Input 110 then is internally connect to energy consumption measurement module 120. The energy consumption measurement 120 collects necessary data of voltage and current from the first input 110 and report to a controller 160 through internal bus 145. In one or more embodiments, the first signal 145 can include, in whole or in part, data in analog or digital format.

In one or more embodiments, the one or more controller 160 can be a dedicated device such as one of the family of Intel Pentium, Celeron, Xeon, Itanium microprocessors, or the like. In one or more embodiments, the one or more controller 160 can be a portion of a device such as a RISC based processor such as one of the family of ARM, PowerPC, MIPS or Intel 8051 in a simple electronic device, or the like.

The controller 160 can also be operably connected to one or more dynamic random access memory (“DRAM”) modules 170 and one or more flash memory modules 180. The output of energy consumption measurement 120 is connect to a power control module 130. The output of a power control module 130 is then connect to the output connector 200, and in turn, connect to the device under load 205. In one or more embodiments, the one or more power control module 130 may connect to the common output of energy consumption measurement 120 or to each of the output of energy consumption measurement 120.

The memory module 170 can include one or more devices, systems, or any combination of systems and/or devices suitable for the temporary or permanent storage of digital data. In one or more embodiments, the memory module 180 can include computer storage media in the form of volatile and/or nonvolatile memory such as read only memory (ROM) and/or random access memory (RAM). A basic input/output system (BIOS), containing the basic routines that help to transfer information between elements within the computing device 160, for example during start-up, can be stored in Flash memory 180 and DRAM 170 can contain data and/or program modules that are immediately accessible to and/or presently being operated on by the one or more controllers 160. In one or more embodiments, the memory module 180 can be partially or wholly physically and/or electrically detachable or otherwise removable from the illustrative system 100.

The controller 160, based on program decision, can control the power control module 130, through internal bus 165. The power control module 130 can control amount of power deliver to the device under load 205. This can be a percentage of the voltage, current and/or time/phase, from the out of the energy consumption measurement 120. In one or more embodiments, the control signal 165 can include, in whole or in part, data in analog or digital format.

The controller 160 monitor and can communicate to both input 110 side and output to device under load 200 side, via one or more internal bus 155 to communication modules 140 and 150. Communication modules 140 can send or receive information from input 110 side, through internal bus 215. Communication modules 150 can send or receive information from output 200 side from the device under load 205, through internal bus 225. In one or more embodiments, the signal, through internal bus 215 can include, in whole or in part, data in analog or digital format. In one or more embodiments, the signal, through internal bus 225 can include, in whole or in part, data in analog or digital format.

An internal clock module 210 is used to keep track of time and related information.

The controller 160 is optionally connected to User module 190 which may contain a user interface, such as a Light Emitted Diode, Liquid Crystal Display, similar type of device or combination of, to display information of device under load 205, information gathered from the energy consumption measurement 120, and/or from the internal clock module 210. The User module 190 is optionally contain one, two or more input means that when pressed, allow controller 160 to change operation mode or change the information displayed on the Liquid Crystal Display.

The controller 160 is optionally connected to a local interface 185 through internal bus 175. The local interface 185 can be any type of network, wired or wireless, universal serial bus, EIA RS-232, RS-485, similar type of inter-connection commonly used for communication or combination of, to facilitate internal information to external other control device and or other illustrative system 100. In one or more embodiments, the local interface 175 can permit bi-directional communication of one or more signals via all or a portion of the one or more cables and/or bus 185.

In one or more embodiments, one or more inputs 110 can be disposed in, on, or about the illustrative system 100. In one or more embodiments, one or more output 200 can be disposed in, on, or about the illustrative system 100.

In one or more embodiments, all or a portion of the one or more CPUs 160, one or more RAM modules 170, one or more flash memory modules 180, and the one or more the local interface 175 can be partially or completely disposed in, on, or about the illustrative system 100. In one or more embodiments, all or a portion of the one or more local interface 175 can be partially or completely disposed in, on, or about in one or more cables and/or bus 185.

As used herein, the term “computing device” can refer to any device having one or more processors capable of executing one or more sets of instructions. The one or more sets of instructions can be embedded code, for example code programmed into an EEPROM or flash memory module disposed within the device. The one or more sets of instructions can include all or in part, one or more user supplied instruction sets, for example user inputs to a routine executed on the device. Exemplary computing devices can include, but are not limited to, handheld computing devices, such as portable digital assistants (“PDAs”); cellular telephones, cellular computing devices, and the like; portable computers, such as laptop computers, “netbook” computers, and the like; desktop computers; computer workstations; all-in-one computers; electronic devices having video display capabilities, such as televisions, digital picture frames, digital projection systems, and the like.

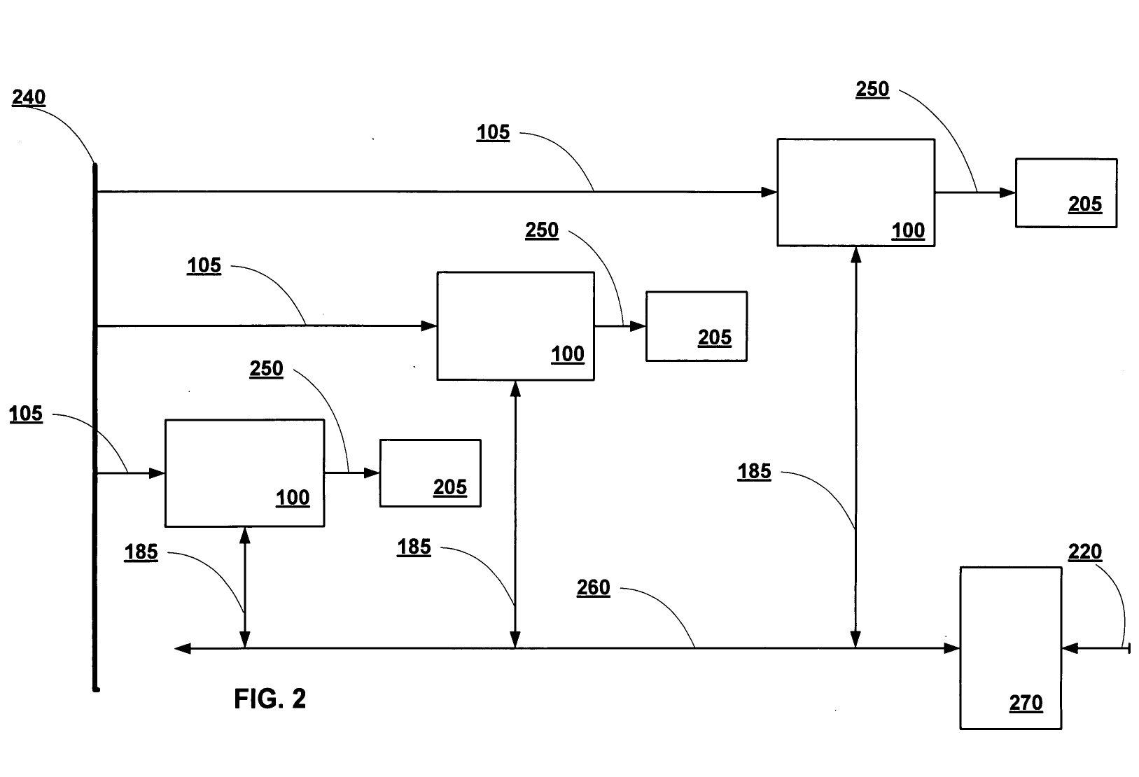

FIG. 2 is a schematic depicting an illustrative system using multiple of the illustrative system 100 depicted in FIG. 1, each with input 105 and the device under load 205, according to one or more embodiments. Each of the input 105 of illustrative system module 100, may be connected to a common power source 240, through cable or bus 230. In one or more specific embodiments, cable or bus 230 from each of the illustrative system 100, may be a common bus or cable or separate bus or cable. In one or more specific embodiments, the connection 250 between the illustrative system 100 and the device under load 205, may be internal, external, cable, socket, or other types operably connected.

In one or more embodiments, each of the illustrative system 100 is optionally connected through the local interface 185, to a master device 270, through cable or a bus 260. An illustrative system of device 270 can refer to any computing device as defined above or may be one of the illustrative system 100 operate as such a device, through software control or other means. In one or more embodiments, illustrative system of device 270 can be bi-directionally, operatively connected to the cable or a bus 260.

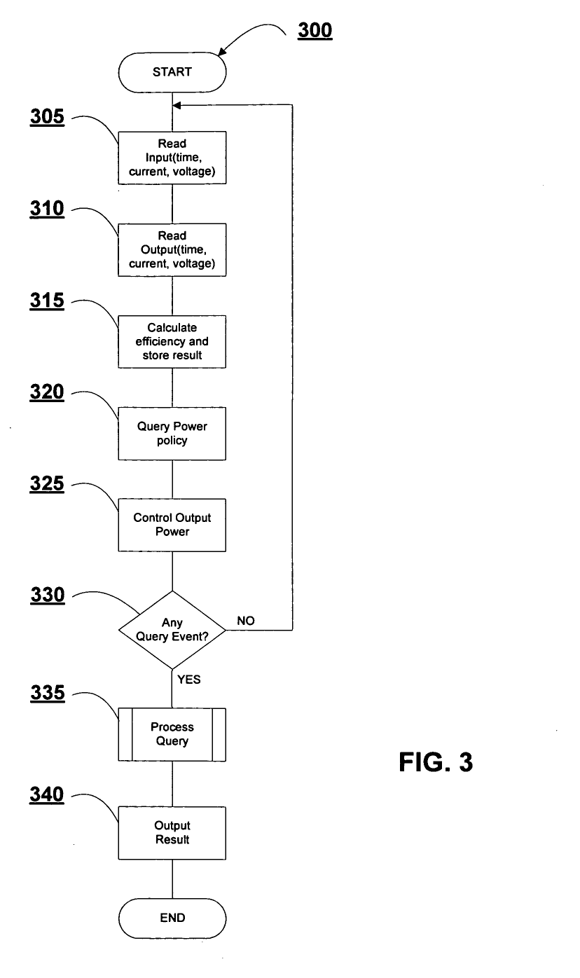

FIG. 3 is a logic flow diagram 300 depicting an illustrative method for networked power control device to collect power consumption data, report collected information, and perform power manipulation to the device under load 205, using the system depicted in FIG. 1, according to one or more embodiments.

In one or more embodiments, in step 305, the controller 160 may obtain the output from energy consumption measurement module 120 and internal clock module 210. An exemplary of such output from the energy consumption measurement module 120, can include, but are not limited to, current and voltage. An exemplary of such output from internal clock module 210, can include, but are not limited to, current time and date, accumulated time and date, locale specific information such as time zone, day light saving, or other relative information. In one or more embodiments, controller 160 may store the result in to one or more memory modules 170 and one or more flash memory modules 180.

In step 310, the controller 160 may obtain the output from power control module 130 and/or combination with one or more memory modules 170 and one or more data previously stored in flash memory modules 180. An exemplary of such output from the from power control module 130, can include, but are not limited to, current and voltage. An exemplary of data previously stored in one or more memory modules 170 and one or more flash memory modules 180, can include, but are not limited to, calculation result in step 305.

In step 315, the controller 160 can calculate the power efficiency result based on the measurement data made in step 305 and step 310. An exemplary of consumption efficiency calculation can based on the ratio of the product of current and voltage obtained in step 305 divide by the product of current and voltage obtained in step 310. Other exemplary of power calculation can based on partial information obtained in step 305 and step 310.

Controller 160 can then store the calculation result to one or more memory modules 170 and one or more flash memory modules 180 for later use.

In step 320, Controller 160, reads the current power policy, from one or more memory modules 170 and/or one or more flash memory modules 180, and/or time information from internal clock module 210. Controller 160, then based on the power policy and time obtained from internal clock module 210, can decide the task required to perform.

In step 325, Controller 160 can then output signal to power control module 130, based on the decision obtained in step 320. The output from controller 160, may adjust the output of power control module 130 to the device under load 205, through the output connector 200. An exemplary of the adjust from the power control module 130 to the device under load 205, can include, but are not limited to, different current and voltage setting.

In step 330, controller 160 will observe and query via one or more internal bus 155 to the outside communication module 140, the inside communication module 150 and the local interface 185 through internal bus 175. If there are no request, then controller 160 will return back to step 305 and continue the process.

If there are requests, from the outside communication module 140, the inside communication module 150, the user module 190 and/or the local interface 185, then controller 160 will enter step 335 to process such request.

An exemplary of the request from outside communication module 140, can include, but are not limited to, a request from master device 270, and/or a “Hello” request from other illustrative system 100 as depicted in FIG. 2.

An exemplary of the request from inside communication module 150, can include, but are not limited to, a request from the device under load 205, if it has the ability to communicate in the same mean.

An exemplary of the request from the local interface 185, can include, but are not limited to, a request from master device 270.

An exemplary of the request from user module 190 can include, but are not limited to, a user push button, switch or other indication.

In step 335, controller 160 will respond to each of the request, compare and process the decision based on software programming, then record the result in one or one or more RAM modules 170, and/or one or more flash memory modules 180. Such decision, will then be registered and process when the controller 160 return to step 320 in next loop.

In step 340, controller 160 will process the local input on user module 190 such as switches, button or other user operable input and then register such event in one or one or more RAM modules 170, and/or one or more flash memory modules 180.

Controller 160 will then update the display on user module 190 to report the current result, based on previous setting. An exemplary of the display information on user module 190, can include, but are not limited to, current power usage of the device under load 205, current input condition such as voltage, current, obtained in step 305, current output condition such as voltage, current, obtained in step 310, current power efficiency result obtained in step 315, current query or result obtained in step 335.

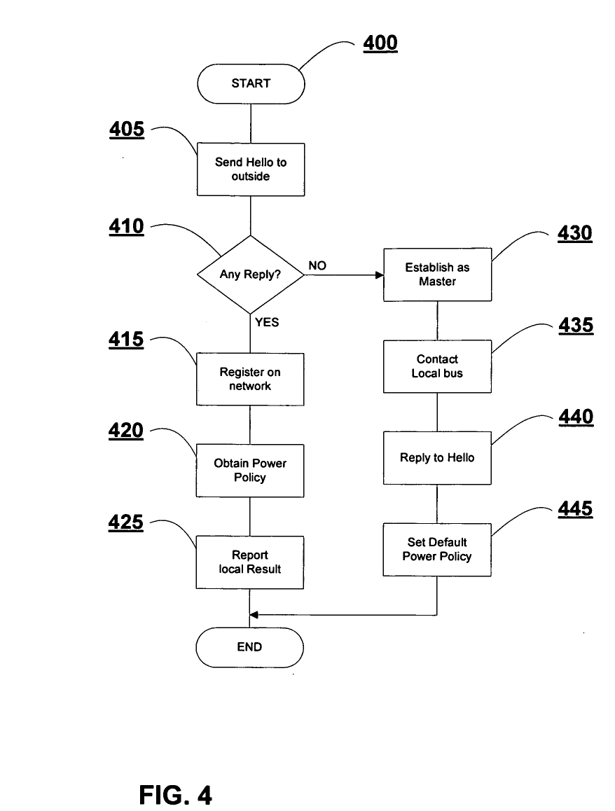

FIG. 4 is a logic flow diagram 400 depicting an illustrative method for the network power control device 100 to establish communication to other network power control device 100 as illustrated in FIG. 2.

When the control device 100 first put on the common power source 240, controller 160 will communicate via internal bus 155 to communication modules 140. In step 405, controller 160 will first send out a “Hello” Request, as described in step 335.

Controller 160, in step 410, will then listen to the communication module 140 and wait for a random period of time, to allow other devices 270 on the common power source 240 to reply, as described in step 335.

In step 410, is other devices replied and claim as the master device 270, the controller 160 will then move to step 415. Controller 160 will read the unique self described information from one or more flash memory modules 180, provide necessary detail to the master device 270 via the communication modules 140.

In step 420, controller 160 can receive from the master device 270 via the communication modules 140, include, but are not limited to, local time, power policy update, other setting.

Controller 160, upon receive the local time from master device 270, can compare and store to the internal clock module 210. Controller 160, upon receive the power policy, can compare then store to one or more RAM modules 170, and/or one or more flash memory modules 180.

An exemplary of other setting, can include, but are not limited to, control and information for the device 100, information to display on user module 190, and on description for the specific device under load 205.

In step 425, controller 160 will then read from one or more RAM modules 170, and/or one or more flash memory modules 180, then send local report via communication modules 140 or through local interface 185 to the master device 270.

An exemplary of local report, can include, but are not limited to, information obtained in step 305, step 310, step 315, and/or information from the device under load 205.

In step 410, if after a random period of time and retries, controller 160 will determine that it is the first device on the common power source 240, and or the only device. In this case, it will enter step 430 and assume the process as the master device 270.

In step 435, controller 160 will try to contact local bus 185 and wait for a random period of time to see if any user input is entered through user module 190. If controller 160 receive setting via the local bus 185 from external means, then it will store in RAM modules 170, and/or flash memory modules 180, and mark as local power policy (goal).

In step 440, controller 160 will listen and try to reply if any other system device 100 has send a “Hello” Request. If controller 160 receive any “hello” Request, then it will reply and provide a copy of local power policy obtained from step 435.

In step 445, controller 160 of the master device 270 will communicate via the local bus 185 and/or outside communication module 140, to other system device 100, to establish the power policy.

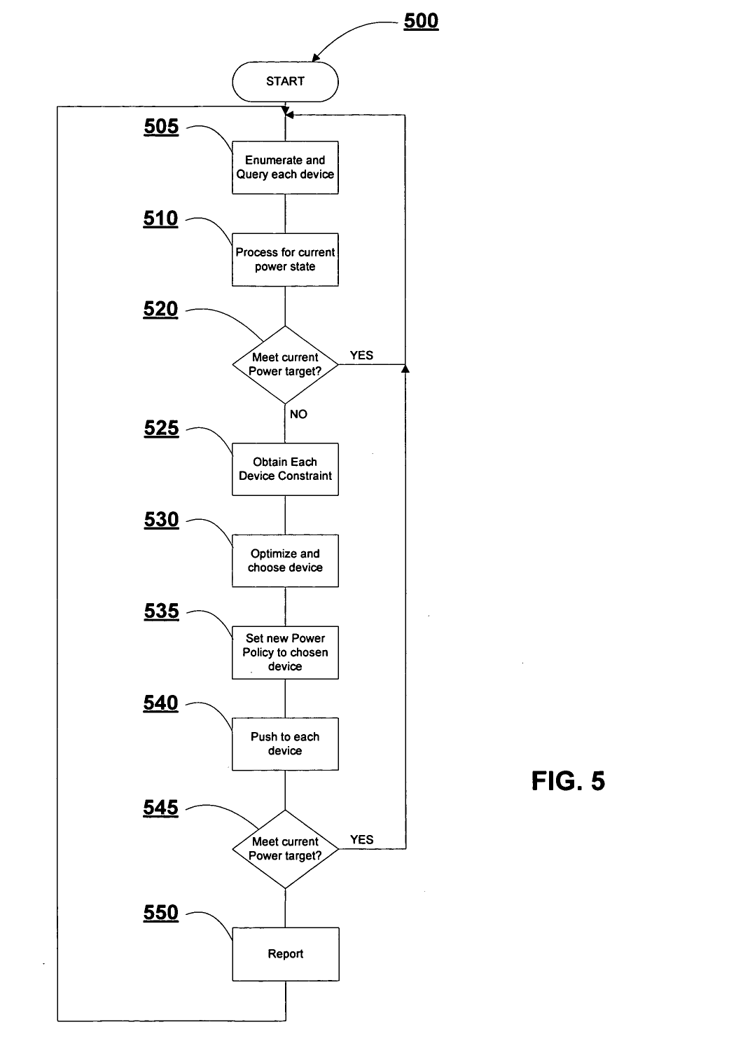

FIG. 5 is a logic flow diagram 500 depicting an illustrative method for the master control device 270 to optimize the local power policy.

In step 505, master device 270 will enumerate the list of system device 100 that are connected to the common power source 240 as illustrated in FIG. 2. Controller 160 inside master device 270 can read from RAM modules 170, and/or flash memory modules 180, of each of local report, as sent by each system device 100 in step 425. Step 505 may be repeated periodically by master device 270 to complete the network topology map as some of the system device 100 may not respond immediately, some of the time or from time to time.

In step 510, master device 270 can calculate the total system power consumption, efficiency, and other data, similar to the process in step 315 and store the result to RAM modules 170, and/or flash memory modules 180. An exemplary of other data can be, but not limited to, peak or minimum load of the entire system, time of day of peak loading, average of power consumption, and/or which system controller 100 has the max or min loading.

In step 520, master device 270 can compare the calculated result from step 510 with power policy set in the step 435. If the result from step 510 meets or below the power policy set in step 435, then the process will return to step 505 and continue. If the result from step 510 is exceeding the power policy set in step 435, then the process will move to step 525.

In step 525, controller 160 in master device 270 will read the local report of each device 100 enumerated in step 505, from RAM modules 170, and/or flash memory modules 180. Controller 160 will obtain each device constrain and form a goal function for all the devices on common power source 240. An exemplary of goal function may be calculate the linear combination of each of the device 100 power value, multiple by time and use each of the device 100 reported upper and lower value as constrain and optimize for minimax.

In step 530, controller 160 will then read the local and choose the device 100 that can accept new policy to reduce power consumption.

In step 535, master device 270 can set a new power policy for the selected device 100 and repeat step 520 to check against power goal.

In step 540, master device 270 can send the new policy to that selected device 100 and wait for the device to report back of new local report.

In step 545, master device 270 can then compare the new result again with power policy goal set in the step 435. If the goal is met, the master device 270 can return to monitor state at step 505. If the goal is not met, the master device 270 can repeat from step 525 to step 540 or failed. If the optimization failed, then master device can enter step 550 and report to user through user module 190 and/or local bus 185.

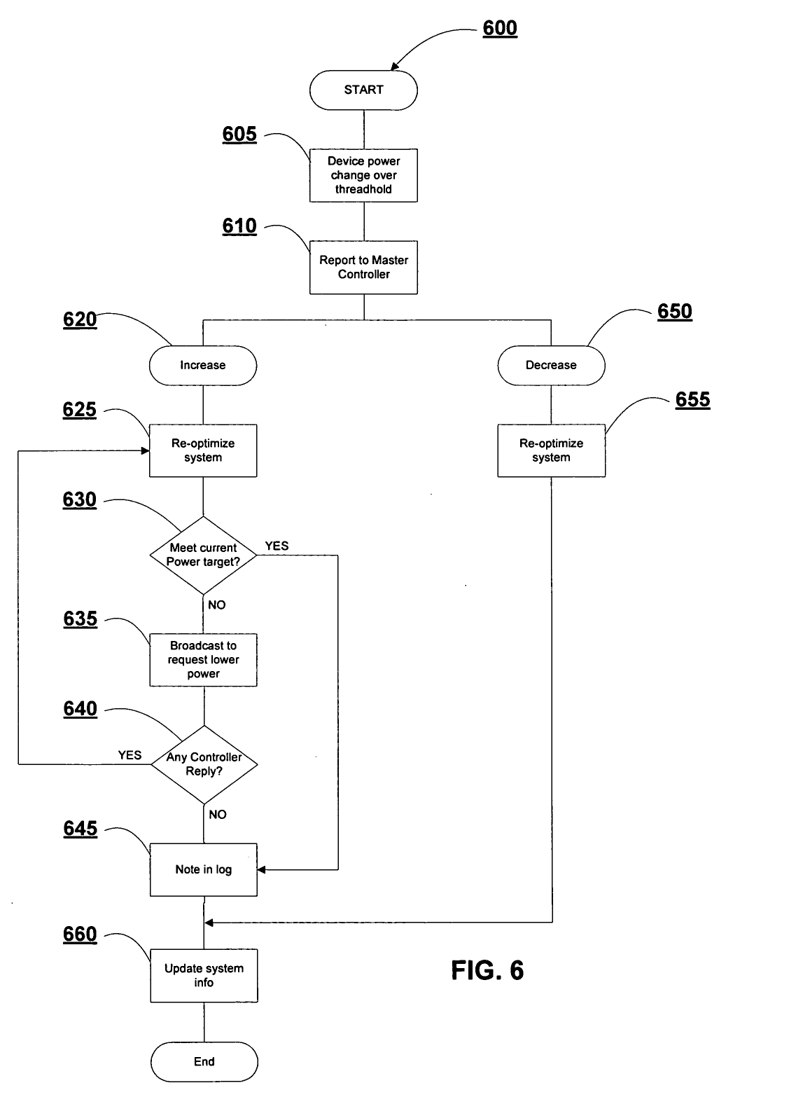

FIG. 6 is a logic flow diagram 600 depicting an illustrative method when one of the device under load 205 change its power consumption value.

In step 605, system device 100 notice the device under load 205 change it power consumption over a pre-defined value.

In step 610, system device 100 will communicate, via communication module 140, the common power bus 105, to master device 270 about such power consumption change.

If such event report to master device 270 is such that, the device under 205, increase its power consumption value, then the control will transfer to step 620 side. If such event report to master device 270 is such that, the device under 205, decrease its power consumption value, then the control will transfer to step 650 side.

In step 625, master device 270 is able to calculate the new total system power consumption, efficiency, and other data, similar to the process in step 315 and store the result to RAM modules 170, and/or flash memory modules 180.

In step 630, master device 270 is then compare the new value obtained in step 625 to the value of local power policy set in step 435.

If the new total system power consumption, efficiency, and other data, obtained in step 625 is still within the value of local power policy set in step 435, then the control is transfer to step 645.

If the new total system power consumption, efficiency, and other data, obtained in step 625 is outside the value of local power policy set in step 435, then in step 635, master device 270 will communicate with each of the controller 100 in FIG. 2 to query if it is possible to reduce power consumption.

In step 640, master device 270 will check if any of the controller 100 in FIG. 2 is able to reduce the power consumption. If no controller 100 is report able to reduce power consumption, then the control is transfer to step 645.

In step 640, if any controller 100 in FIG. 2 replied with new lower power consumption value, then the mast device 270 will repeat step 625, until a new system optimized power consumption result is obtained.

In step 645, master controller 270 will record such power change event and store in one or more RAM modules 170, one or more flash memory modules 180 and display in local user module 190.

In step 660, master controller 270 will record and continue to seek to lower the total system power consumption to meet the power policy set in step 435.

In step 650, master controller 270 will record the new value reported and calculate the new total system power consumption, efficiency, and other data, similar to the process in step 315 and store the result to RAM modules 170, and/or flash memory modules 180.

Master controller 270 will continue repeat the loop to optimize the system power consumption periodically to meet the power policy set in step 435.

The systems and methods described herein (e.g., systems 100 and 200, and methods 300, 400 500 and 600) can be implemented in software, hardware, or any combination thereof. In one or more embodiments, these systems and methods can be implemented in hardware, including, but not limited to, a programmable logic device (PLD), programmable gate array (PGA), field programmable gate array (FPGA), an application-specific integrated circuit (ASIC), a system on chip (SoC), and a system in package (SiP). In one or more embodiments, the systems and methods disclosed herein can be implemented in software that is stored in a memory and that is executed by a suitable microprocessor, network processor, or microcontroller situated in a computing device. This executable code can be embodied in any computer-readable medium for use by or in connection with a processor.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1) A system for network power control device comprising:
a power input operably connected to an energy consumption measurement module then to an external power source and output to a power control module;
a bus connected communication modules operable to send and read communication information;
a internal clock module to provide time information;
a local connection bus and user module to interface;
a controller operatively coupled to the communication modules. clock module, local connection and user module;
wherein the controller is able to obtain power information and time locally, and based on software decision set power output by changing setting in the power control module;
wherein the controller is able to communicate with the device under load via communication module and external master device via communication module; and
wherein the controller is able to communicate with the master device via local connection bus;
wherein the controller is able to display local information and remote information on user module.

2) The system of claim 1,
wherein any of the controller has ability to elect to become the master device through programming or user assignment;
wherein a master device has optionally, the ability to communicate to other controller and/or other type of device such as a personal computer;
wherein a master device has optionally, the ability to communicate to communication devices like gateway or router to transmit/receive to Internet.

3) The system of claim 1,
wherein, the controller is able to transmit/receive control signal and/or data, through local connection, to the master device.
wherein, the controller is able to transmit/receive control signal and/or data, through the common input power connection, to other controllers.

4) The system of claim 1,
wherein, user may set the operation of the controller and obtain the operation result of the controller locally;
wherein, user may set the operation of the controller and obtain the operation result of the controller remotely through master device;
wherein, user may set the operation of the controller and obtain the operation result of the controller remotely through other type of device such as a personal computer.

5) The system of claim 1,
wherein, user may set the operation of the controller to obtain a predefined amount of power from the source in the form of certain voltage, current, time of day operation, on/off, duty cycle;
wherein, user may set the operation of the controller to meet a predefined value for the device under load, in the form of operation time, amount of energy, or monetary value.

6) A method for networks of controllers to optimize total system power consumption comprising:
providing system wide or individual power consumption information by the master device and local display in real time;
providing system wide or individual device power consumption historic information with time stamp by the master device and local display;
providing system wide or individual device power consumption type information with time stamp by the master device and local display;
by associating real time power consumption information with historic information as system wide power consumption trend;
by associating individual power consumption type information as constraint value, therein;
by using the constraint value to set maximum and minimum of system wide power consumption value;
Operatively setting the system wide power consumption goal; and
Calculate the optimized individual power consumption value within the limit of constraint value; program each of the controller in system with the optimized individual power consumption value; and
Report the difference of optimized system wide power consumption value and power consumption goal.

7) The method of claim 6,
wherein, the individual power consumption information comprising, in whole or in part, one or more of voltage, current, time, transient, noise, duty cycle and error value;
wherein, the power consumption information is represented in whole or in part, one or more of binary data format, human readable, machine readable, raw, compressed and/or encoded.

8) The method of claim 6,
wherein, the device constraint value is represented, in whole or in part, one or more of maximum, minimum, average, optimized, or set points;
wherein, the device constraint value is represented, in whole or in part, one or more of binary data format, human readable, machine readable, raw, compressed and/or encoded; and
wherein, the system wide power consumption goal is represented in whole or in part, one or more of maximum, minimum, preferred, time of day, period, cycle, percentage, ratio and/or best effort;
wherein, the system wide power consumption goal is represented, in whole or in part, one or more of binary data format, human readable, machine readable, raw, compressed and/or encoded.

9) The method of claim 6,
wherein, the calculation of optimized individual power consumption value is repeated as necessary as system required;
wherein, the optimized individual power consumption calculated value is represented in whole or in part, one or more of binary data format, human readable, machine readable, raw, compressed and/or encoded; and
wherein, the device is able to communicate the optimized power consumption value to other devices.

10) A method of networks of controllers to communicate and request other devices to reduce power to meet total system power consumption value, comprising:
by using communication means to requests other controller to reduce power consumption to meet power policy for entire system.
